(19) United States
(12) Patent Application Publication
(10) Pub. No.: US 2026/0084666 A1
(43) Pub. Date: Mar. 26, 2026

(54) PEDAL DEVICE

(71) Applicant: DENSO CORPORATION, Kariya-city (JP)

(72) Inventors: Genki SUZUKI, Kariya-city (JP); Etsugo YANAGIDA, Kariya-city (JP); Yuki MATSUNAGA, Kariya-city (JP); Kengo ITO, Kariya-city (JP)

(21) Appl. No.: 19/367,461

(22) Filed: Oct. 23, 2025

Related U.S. Application Data
(63) Continuation of application No. PCT/JP2024/011429, filed on Mar. 22, 2024.

(30) Foreign Application Priority Data
Apr. 27, 2023 (JP) 2023-073557

(51) Int. Cl. B60T 7/06; B60T 7/04

(52) U.S. Cl. CPC B60T 7/06; B60T 7/042

(57) ABSTRACT

A housing is fixed to a vehicle. A pedal arm is provided at the housing to be rotatable about an axis within a predetermined angular range, and has a pedal operation part positioned at an upper side of the vehicle above the axis, which is a part stepped on by a driver. A covering member is provided at the pedal art and covers all or part of an area outside the housing, where the pedal arm rotates and operates, which is a front side of the vehicle, a right side in a vehicle width direction and a left side in the vehicle width direction, relative to a pedal operating area.

### CROSS REFERENCE TO RELATED APPLICATIONS

The present application is a continuation application of International Patent Application No. PCT/JP2024/011429 filed on Mar. 22, 2024, which designated the U.S. and claims the benefit of priority from Japanese Patent Application No. 2023-073557 filed on Apr. 27, 2023. The entire disclosures of all of the above applications are incorporated herein by reference.

### TECHNICAL FIELD

The present disclosure relates to a pedal device to be mounted on a vehicle.

### BACKGROUND

Organ-type pedal devices installed in vehicles have been known conventionally. The pedal device includes a support plate fixed to a vehicle floor, a pedal body rotatable around a pin provided on the support plate, and a covering member that surrounds a portion of the pedal body on a rear side of the vehicle. The covering member prevents foreign matter such as carpets, mats, and pebbles from being caught between a portion of the pedal body on a rear side of the vehicle and a vehicle floor.

However, in the pedal device, there is an area between a portion of the pedal body on a front side of the vehicle and the vehicle floor, which is not covered by the covering member.

### SUMMARY

According to an exemplar of the present disclosure, a pedal device mounted on a vehicle includes, a housing fixed to the vehicle; and a pedal arm provided to be rotatable within a predetermined angular range about a predetermined axis with respect to the housing, and having a pedal operation part as a part to be stepped on by a driver on an upper side of the vehicle above the axis. A covering member is provided at the pedal arm to cover all or a part of an area outside of the housing, where the pedal arm rotates and operates, which is a vehicle front side, a right side in a vehicle width direction, and a left side in the vehicle width direction with respect to a pedal operating area.

### BRIEF DESCRIPTION OF THE DRAWINGS

Objects, features, and advantages of the present disclosure will become more apparent from the following detailed description made with reference to the accompanying drawings, in which:

FIG. 1 is a side view of a pedal device according to a first embodiment;

FIG. 2 is an arrow view in a II direction of FIG. 1;

FIG. 3 is a cross-sectional view taken along a line III-III of FIG. 2;

FIG. 4 is a cross-sectional view of a full stroke state in the pedal device according to the first embodiment;

FIG. 5 is a cross-sectional view of a pedal device according to a second embodiment;

FIG. 6 is a cross-sectional view of a pedal device according to a third embodiment;

FIG. 7 is a cross-sectional view of the full stroke state in the pedal device according to the third embodiment;

FIG. 8 is a cross-sectional view of a pedal device according to a fourth embodiment;

FIG. 9 is a cross-sectional view of a pedal device according to a fifth embodiment;

FIG. 10 is an arrow view in an X direction of FIG. 9;

FIG. 11 is an enlarged view of a portion XI in FIG. 9;

FIG. 12 is a cross-sectional view taken along a line XII-XII of FIG. 9;

FIG. 13 is a diagram of a part corresponding to FIG. 10 in a pedal device according to a sixth embodiment;

FIG. 14 is a cross-sectional view of a pedal device according to a seventh embodiment;

FIG. 15 is a cross-sectional view taken along a line XV-XV in FIG. 14;

FIG. 16 is an arrow view in a XXVII direction of FIG. 14;

FIG. 17 is a cross-sectional view of a part corresponding to FIG. 15 in a pedal device according to an eighth embodiment;

FIG. 18 is a side view of a pedal device according to a ninth embodiment;

FIG. 19 is an arrow view in a XIX direction of FIG. 18;

FIG. 20 is a diagram of a part corresponding to FIG. 19 in a pedal device according to a tenth embodiment;

FIG. 21 is a side view of a pedal device according to an eleventh embodiment;

FIG. 22 is a cross-sectional view taken along a line XXII-XXII of FIG. 21;

FIG. 23 is a side view of a pedal device according to a twelfth embodiment;

FIG. 24 is a cross-sectional view taken along a line XXIV-XXIV of FIG. 23; and

FIG. 25 is a cross-sectional view of a part corresponding to FIG. 24 in a pedal device according to a thirteenth embodiment.

### DESCRIPTION OF EMBODIMENTS

When foreign matter, such as an empty can is caught between a vehicle floor and a portion of a pedal device on a front side of the vehicle, it may restrict a rotation of a pedal arm, and the pedal arm may lock up.

It is an object of the present disclosure to provide a pedal device capable of preventing a pedal arm from locking due to intrusion of foreign matter.

According to an exemplar of the present disclosure, an organ-type pedal device mounted on a vehicle includes, a housing fixed to the vehicle; a pedal arm provided to be rotatable within a predetermined angular range about a predetermined axis with respect to the housing, and having a pedal operation part as a part to be stepped on by a driver on an upper side of the vehicle above the axis; and a covering member provided at the pedal arm and covering all or a part of an area outside of the housing, where the pedal arm rotates and operates, which is a vehicle front side, a right side in a vehicle width direction, and a left side in the vehicle width direction with respect to a pedal operating area.

According to the above, when foreign matter having a size that makes it difficult to operate the pedal arm approaches the pedal device from the vehicle front side, from the right side or from the left side of the vehicle in the vehicle width direction, the covering member can prevent the foreign matter from entering the pedal operating area. Thus, in the pedal device, it can prevent the pedal arm from locking due to intrusion of foreign matter into the pedal operating area.

Embodiments of the present disclosure will now be described with reference to the drawings. In the following embodiments, the same or equivalent parts are denoted by the same reference numerals as each other, and explanations will be provided to the same reference numerals. In each figure, the arrows indicate the front of the vehicle, rear of the vehicle, up in the vehicle, down in the vehicle, right side in the vehicle width direction, and left side in the vehicle width direction when the pedal device is installed in the vehicle. An upper part of the vehicle may be referred to as a sky direction when a component is mounted on the vehicle.

### First Embodiment

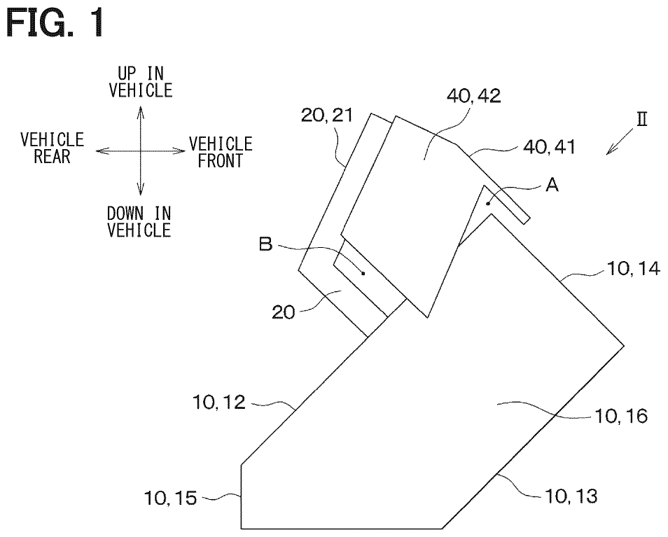

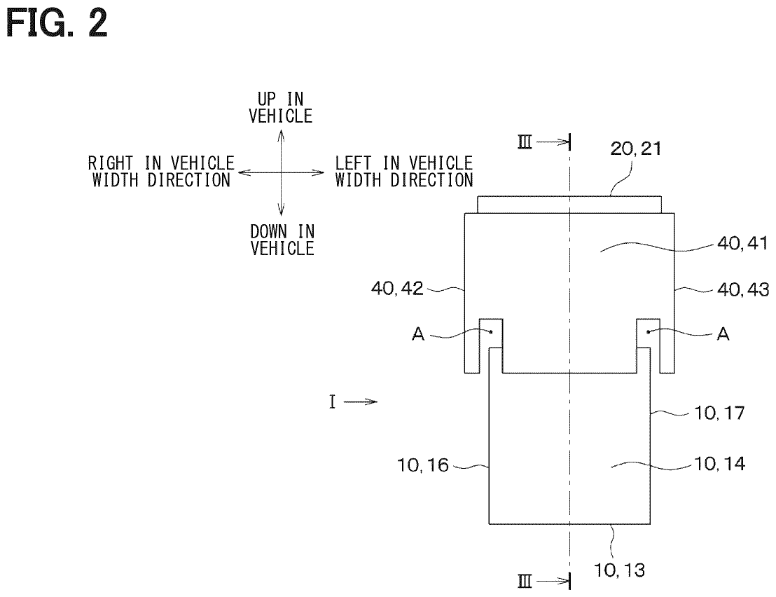

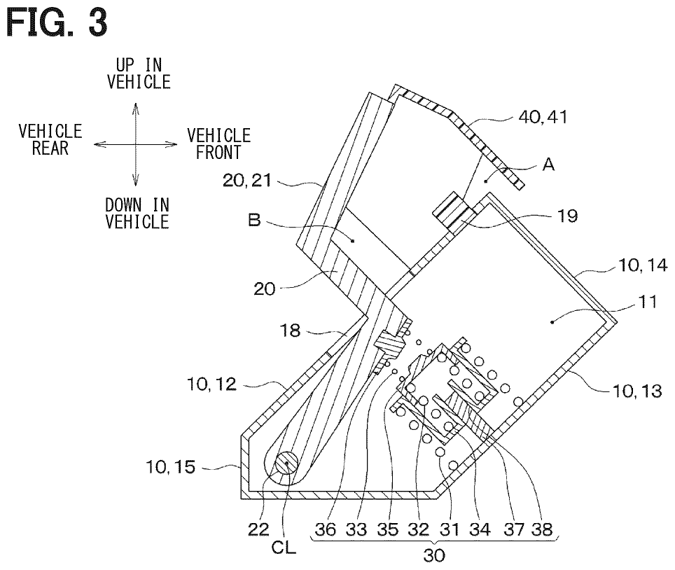

The first embodiment will be described with reference to FIGS. 1 to 4. The first embodiment describes a brake pedal device as an example of a pedal device installed in a vehicle. The brake pedal device can be used, for example, in a brake-by-wire system. A brake-by-wire system is a system in which an electronic controller installed in the vehicle drives and controls a brake circuit to brake each wheel based on electrical signals output from an unshown sensor provided in a brake pedal device.

As shown in FIGS. 1 through 4, the pedal device is an organ-type pedal device, and includes a housing 10, a pedal arm 20, a reaction force generating mechanism 30, and a covering member 40. An organ-type pedal device refers to a configuration in which a pedal operation part 21 as a part of the pedal arm 20 that is stepped on by a driver is positioned in a sky direction when mounted on the vehicle, i.e., in an upper part of the vehicle, relative to an axis CL of rotation of the pedal arm 20. Further, in the organ-type pedal device, a part of the pedal arm 20 that is higher than the axis CL in the vehicle rotates and moves toward a floor or dash panel of the vehicle in response to an increase in a pedal force applied by a driver to the pedal operation part 21.

The housing 10 is fixed to the floor or dash panel of the vehicle by bolts or other means not shown. The housing 10 has an interior space 11 inside it. The interior space 11 of the housing 10 houses a portion of the pedal arm 20, a shaft member 22, the reaction force generating mechanism 30 and the like.

The housing 10 includes a top wall 12, a bottom wall 13, a front wall 14, a rear wall 15, a right side wall 16, and a left side wall 17. The top wall 12 is a wall of the housing 10 that faces above and behind the vehicle, and the bottom wall 13 is a wall of the housing 10 that faces below the vehicle, i.e., toward the floor or dash panel. The front wall 14 is a wall of the housing 10 that faces front and up in the vehicle, and the rear wall 15 is the wall of the housing 10 that faces rearward. The right side wall 16 is a wall of the housing 10 that faces the right side of the vehicle in the width direction, and the left side wall 17 is a wall of the housing 10 that faces the left side of the vehicle in the width direction.

The housing 10 has an opening 18 in a portion of the top wall 12. The pedal device is configured to have the pedal arm 20 and the reaction force generating mechanism 30 that can be attached and detached via the opening 18 in the housing 10.

The pedal arm 20 has its rear and lower part in the vehicle inserted into the interior space 11 of the housing 10, and has its middle part passing through the opening 18, and has its front and upper part in the vehicle positioned outside of the housing 10. The pedal arm 20 has its rear and lower part in the vehicle rotatably connected to the housing 10 by a shaft member 22. The pedal arm 20 has the pedal operation part 21, as a part on an upper side of the vehicle above the axis CL to be stepped on by the driver.

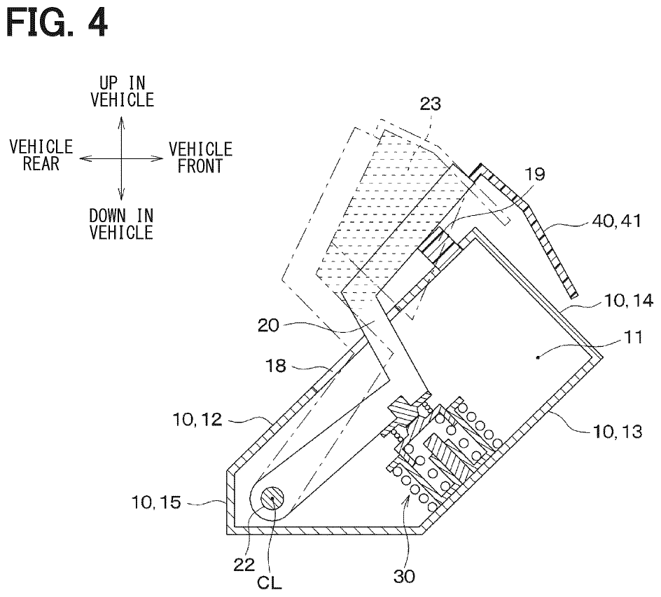

FIG. 1 shows a state in which the driver's pedal force is not applied to the pedal operation part 21. In the following description, such a state is referred to as an “initial state.” FIG. 4, on the other hand, shows the pedal operation part 21 at its closest approach to the housing 10 when the driver's pedal force is applied to the pedal operation part 21. In the following description, such a state is referred to as a “full stroke state. In the full stroke state, the pedal arm 20 contacts a stopper 19 provided on the housing 10.

Note that, in FIG. 4, positions of the pedal arm 20 and the covering member 40 in the initial state are shown by a one-dot chain line. As shown in FIG. 4, the pedal arm 20 rotates and moves within a predetermined angular range about a predetermined axis CL relative to the housing 10. In the first embodiment, the predetermined axis CL coincides with the axis CL of the shaft member 22. In the following description, an area in which the pedal arm 20 rotates and operates outside the housing 10 is referred to as an “pedal operating area 23.” In FIG. 4, the pedal operating area 23 is shown with a hatching of broken lines.

In the inner space 11 of the housing 10, a reaction force generating mechanism 30 is provided on the opposite side of the pedal arm 20 from the pedal operation part 21. The reaction force generating mechanism 30 generates a reaction force to the pedal force applied by the driver to the pedal arm 20. By providing the reaction force generating mechanism 30, the pedal device can provide the same reaction force as the one when the pedal arm 20 and a master cylinder are connected, even when the mechanical connection between the pedal arm 20 and the master cylinder is eliminated.

The reaction force generating mechanism 30 of the first embodiment consists of a plurality of elastic members to obtain desired pedal force characteristics. For example, the reaction force generating mechanism 30 has a first coil spring 31, a second coil spring 32, a third coil spring 33, a first holder 34, a second holder 35, a third holder 36, a central rod 37 and the like. The central rod 37 is fixed at one end to the bottom wall 13 of the housing 10, and extends toward the pedal arm 20. The first holder 34 has an insertion hole 38 through which the central rod 37 is inserted. An inner wall of the insertion hole 38 of the first holder 34 and the central rod 37 slide against each other, and the first holder 34 can move back and forth in a direction in which the central rod 37 extends. An outer wall of the second holder 35 slides against the inner wall of the first holder 34, and the second holder 35 can also move back and forth in the direction in which the central rod 37 extends. The third holder 36 is fixed to a part of the pedal arm 20 opposite to the pedal operation part 21. The first coil spring 31 is positioned between the bottom wall 13 of the housing 10 and the first holder 34. The second coil spring 32 is positioned between the first holder 34 and the second holder 35. The third coil spring 33 is positioned between the second holder 35 and the third holder 36. The first coil spring 31, the second coil spring 32 and the third coil spring 33 are all compression coil springs.

The covering member 40 is provided on the pedal arm 20, and covers all or part of the front side of the vehicle, the right side in the vehicle width direction and the left side in the vehicle width direction with respect to the pedal operating area 23. Note that, in the first embodiment, the covering member 40 covers a portion of the front side of the vehicle, the right side of the vehicle in the vehicle width direction, and the left side of the vehicle width direction with respect to the pedal operating area 23. Therefore, there are areas A and B of the pedal operating area 23 of the pedal arm that are not covered by the covering member 40 on the front side of the vehicle and on the right and left sides of the vehicle in the vehicle width direction.

The covering member 40 is connected to the pedal arm 20 by a part on a pedal arm 20 side. The covering member 40, being made of a separate component from the pedal arm 20, may be joined to the pedal arm 20 or to the pedal operation part 21. Alternatively, the covering member 40 may be integral with the pedal arm 20 or the pedal operation part 21.

A part or all of the material of the covering member 40 is formed by resin, rubber or elastomer. The resin employed as the covering member 40 is a material that can be elastically deformed by the driver's pedal force, such as polyvinyl chloride (PVC: polyvinyl chloride). Further, the rubber or the elastomer employed as the covering member 40 is also a material that deforms under normal driver's pedal force.

The covering member 40 includes a front covering part 41, a right covering part 42, and a left covering part 43. The front covering part 41 is a portion of the covering member 40 that faces the front and up in the vehicle. The right covering part 42 is a portion of the covering member 40 that faces right in the vehicle width direction, and the left covering part 43 is a portion of the covering member 40 that faces left in the vehicle width direction.

In the initial state, at least a part of a housing 10 side portion of the covering member 40 is positioned on a lower side of the vehicle below the upper wall 12 of the housing 10. That is, the covering member 40 extends from the pedal arm 20 toward the housing 10, and at least a part of the housing 10 side portion of the covering member 40 covers an outside of the housing 10. Specifically, a part of the housing 10 side portion of the front covering part 41 covers an outside of the front wall 14 of the housing 10. A part of the housing 10 side portion of the right covering part 42 covers the outside of the right side wall 16 of the housing 10, and a part of the housing 10 side portion of the left covering part 43 also covers the outside of the left side wall 17 of the housing 10. The covering member 40 can prevent foreign matter, such as empty cans, for example, which are large enough to make operation of the pedal arm 20 difficult, from entering the pedal operating area 23. Note that the housing 10 side portion of the covering member 40 is a portion of the covering member 40 that faces, in the initial state, the housing 10 in a normal direction of the front wall 14, the right side wall 16, and the left side wall 17, respectively.

The pedal device of the present embodiment described above has the following effects.

(1) In the first embodiment, the covering member 40 provided in the pedal device covers a portion of the front side of the vehicle, a portion of the right side in the vehicle width direction, and a portion of the left side in the vehicle width direction with respect to the pedal operating area 23. According to the above, when foreign matter of a size that makes it difficult to operate the pedal arm 20 approaches the pedal device from the front side of the vehicle, from the right or left side of the vehicle in the vehicle width direction, the covering member 40 can prevent the foreign matter from entering the pedal operating area 23. Thus, the pedal device can prevent the pedal arm 20 from locking due to intrusion of the foreign matter into the pedal operating area 23.

(2) In the first embodiment, the covering member 40 extends from the pedal arm 20 toward the housing 10, and at least a part of the housing 10 side portion of the covering member 40 covers on the outside of the housing 10. By the way, in the pedal device described in Patent Document 1, a portion of the covering on a vehicle lower side and a member arranged on a floor are fixed to each other with screws in configuration, thereby increasing steps of assembly work for fixing the covering member 40. In contrast, in the first embodiment, without fixing the housing 10 side portion of the covering member 40 to the housing 10 or to the floor, it is possible to prevent intrusion of foreign matter into the pedal operating area 23 by covering the outside of the housing 10 with at least a portion of the covering member 40. Therefore, the pedal device of the first embodiment can reduce the number of steps required to assemble the covering member 40, compared to the configuration described in Patent Document 1.

(3) In the first embodiment, a part or all of the material of the covering member 40 is resin, rubber or elastomer that can be elastically deformed by the driver's pedal force. According to the above, even when foreign matter is caught between the vehicle floor and the covering member 40 when the pedal arm 20 rotates and operates from the initial state to the full stroke state, the covering member 40 can be deformed by the driver's pedal force. Thus, the pedal device can prevent the pedal arm 20 from locking due to intrusion of foreign matter.

### Second Embodiment

The following describes the second embodiment of the present disclosure. The second embodiment is similar to the first embodiment except for a part of the configuration of a housing 10 modified from the corresponding configuration of the first embodiment. Accordingly, only parts different from the corresponding parts of the first embodiment are herein described.

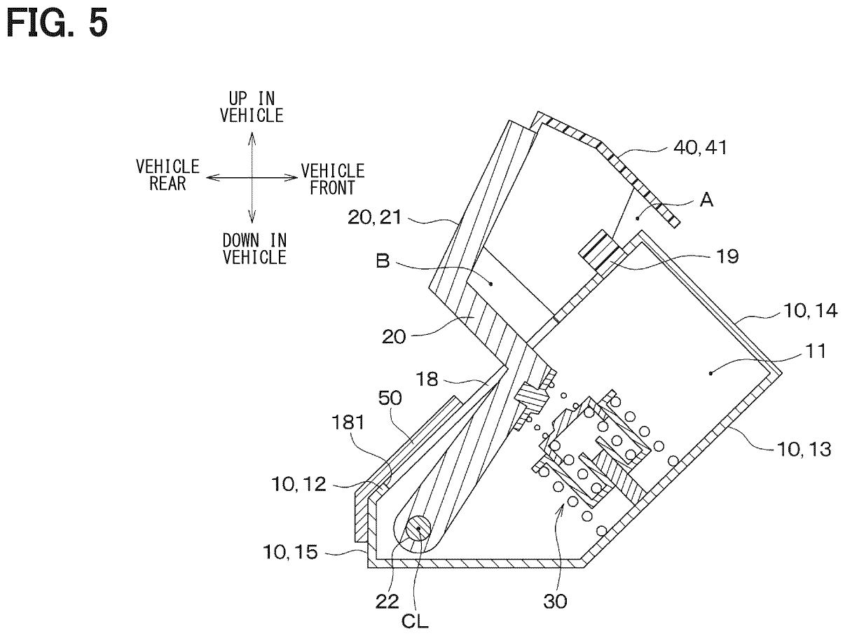

As shown in FIG. 5, in the second embodiment, a size of an opening 18 in the housing 10 is greater toward the rear of the vehicle than that described in the first embodiment. Specifically, an inner edge 181 of the opening 18 on a rear side of the vehicle is positioned further rearward of the vehicle than the shaft member 22. In such manner, a pedal arm 20 and a reaction force generating mechanism 30 are easily insertable into an inner space 11 of the housing 10 via the opening 18 of the housing 10 during assembly of the pedal device, making it easily assembleable to the housing 10.

The second embodiment of the pedal device includes a shielding member 50 that blocks a rear portion of the opening 18 of the housing 10 on a rear side of the vehicle. The shielding member 50 is attached to a top wall 12 or the rear wall 15 of the housing 10 after the pedal arm 20 and the reaction force generating mechanism 30 are assembled in the interior space 11 of the housing 10. In such manner, the shielding member 50 blocks the rear side of the vehicle in the opening 18, thereby preventing foreign matter from entering the interior space 11 via the opening 18.

The pedal device of the second embodiment described above can thus achieve the same effects as those of the first embodiment.

### Third Embodiment

The following describes the third embodiment of the present disclosure. In the third embodiment, the configuration of a covering member 40 is partially changed with respect to the first and second embodiments, and the other configurations are the same as those of the first and second embodiments, and therefore, only portions different from those of the first and second embodiments will be described.

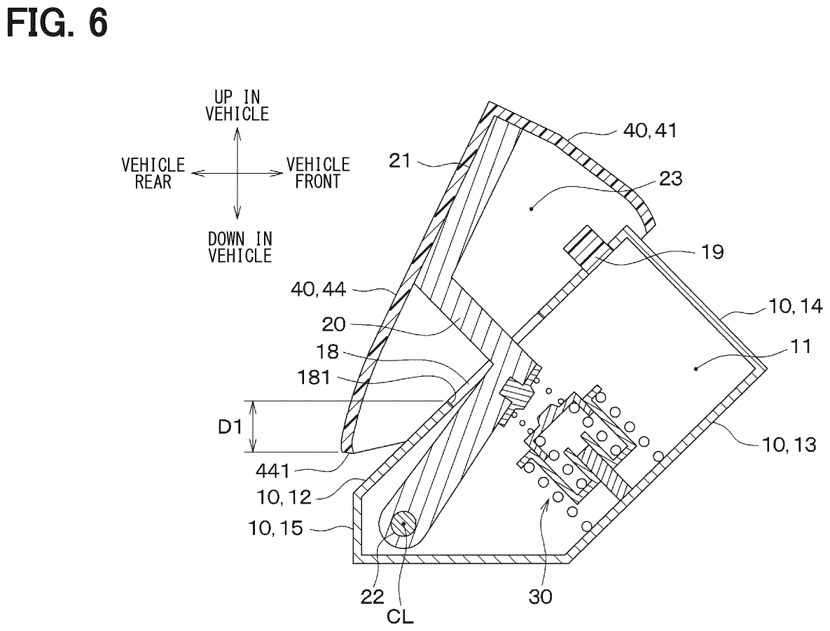

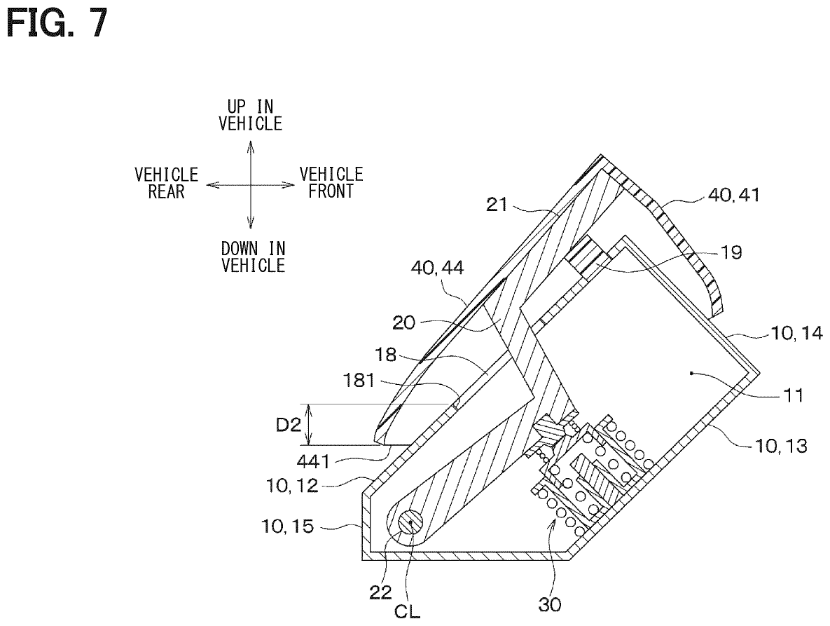

As shown in FIGS. 6 and 7, in the third embodiment, the covering member 40 has an upper covering part 44 in addition to a front covering part 41, a right covering part 42, and a left covering part 43. The upper covering part 44 is a portion of the covering member 40 that faces the rear and up in the vehicle. A portion of the upper covering part 44 that overlaps a pedal arm 20 is the portion that is stepped on by the driver, and is integrally coupled with a pedal operation part 21. In other words, the covering member 40 and the pedal operation part 21 are coupled as one piece.

The covering member 40 covers all of the front side of the vehicle, the right side of the vehicle in the vehicle width direction, and the left side of the vehicle in the vehicle width direction with respect to a pedal operating area 23. In the initial state, a housing 10 side portion of the covering member 40 is positioned below the upper wall 12 of the housing 10, in the vehicle. That is, the covering member 40 extends from the pedal arm 20 toward the housing 10, and a housing 10 side portion of the covering member 40 covers the outside of a right side wall 16, a left side wall 17 and a front wall 14 of the housing 10. Specifically, a housing 10 side portion of the front covering part 41 covers by the outside of the front wall 14 of the housing 10. A housing 10 side portion of the right covering part 42 covers the outside of the right side wall 16 of the housing 10, and a housing 10 side portion of the left covering part 43 covers the outside of the left side wall 17 of the housing 10.

Further, in the third embodiment, the covering member 40 extends rearward of the vehicle beyond the opening 18 in the housing 10. Specifically, the upper covering part 44, the right covering part 42, and the left covering part 43 of the covering member 40 respectively extend rearward of the vehicle beyond the opening 18 of the housing 10. As shown in FIG. 6, in an initial state, a distance D1 in a vehicle vertical direction between a vehicle rearward portion 441 of the covering member 40 and a rearward inner edge 181 of the opening 18 of the housing 10 is greater than 0. Therefore, in the initial state, the vehicle rearward portion 441 of the covering member 40 is positioned below the opening 18 in the vehicle. Note that the vehicle rearward portion 441 of the covering member 40 is a vehicle rearward portion 441 of the upper covering part 44 positioned on a rear side of the vehicle.

Further, as shown in FIG. 7, in a full stroke state, a distance D2 in the vehicle vertical direction between the vehicle rearward portion 441 of the covering member 40 and the rearward inner edge 181 of the opening 18 of the housing 10 is also greater than 0. Therefore, in the full stroke state, the vehicle rearward portion 441 of the covering member 40 is positioned below the opening 18 in the vehicle. In such manner, it is possible for the covering member 40 to prevent foreign matter from entering the interior space 11 of the housing 10 through the opening 18, even when, for example, the foreign matter falls off from a sole of the driver's shoes. Further, the covering member 40 can also prevent foreign matter from entering the pedal operating area 23 and the opening 18 when the foreign matter approaches the pedal device from the rear side of the vehicle.

The pedal device of the third embodiment described above can achieve the following effects in addition to the effects similar to those of the first embodiment.

(1) In the third embodiment, the covering member 40 covers all of the front side of the vehicle, the right side of the vehicle in the vehicle width direction and the left side of the vehicle in the vehicle width direction with respect to the pedal operating area 23. According to the above, when foreign matter approaches the pedal device from the front side of the vehicle, from the right or left side of the vehicle in the vehicle width direction, the covering member 40 can more reliably prevent intrusion of foreign matter into the pedal operating area 23.

(2) In the third embodiment, in the initial state and in the full stroke state, the vehicle rearward portion 441 of the covering member 40 is positioned below in the vehicle than the opening 18. According to the above, the covering member 40 can, for example, prevent foreign matter from entering the interior space 11 of the housing 10 through the opening 18, even when the foreign matter falls off from a sole of the driver's shoes. Further, the covering member 40 can also prevent foreign matter from entering the pedal operating area 23 and the opening 18 when the foreign matter approaches the pedal device from the rear side of the vehicle.

### Fourth Embodiment

The following describes the fourth embodiment of the present disclosure. The fourth embodiment is similar to the third embodiment except for a part of the configuration of a housing 10 modified from the corresponding configuration of the third embodiment. Accordingly, only parts different from the corresponding parts of the third embodiment are herein described.

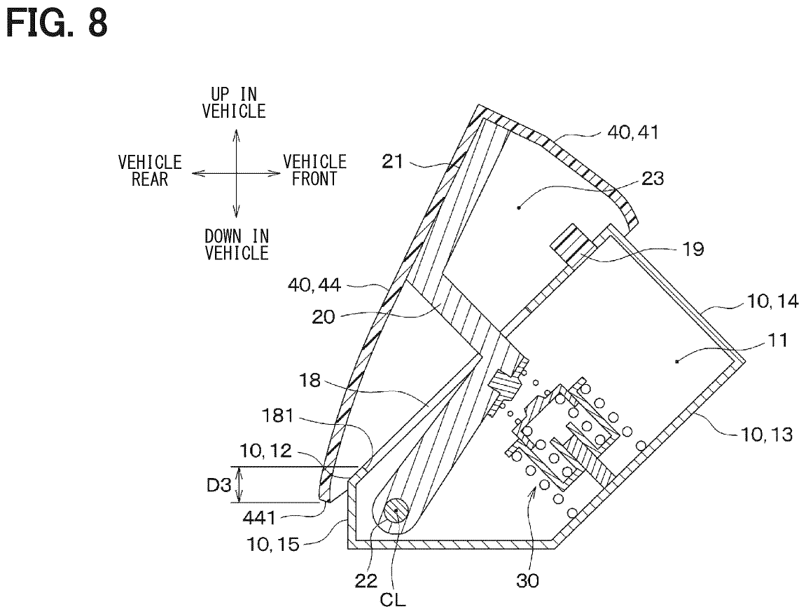

As shown in FIG. 8, in the fourth embodiment, as in the second embodiment, an opening 18 in the housing 10 is greater in size toward the rear of the vehicle than the one in the third embodiment. Specifically, an inner edge 181 of the opening 18 on a rear side of the vehicle is positioned further rearward of the vehicle than the shaft member 22. In such manner, a pedal arm 20 and a reaction force generating mechanism 30 can be easily inserted into an inner space 11 of the housing 10 via the opening 18 of the housing 10 during assembly of the pedal device, making it easily assembleable to the housing 10. Note that the pedal device of the fourth embodiment does not include a shielding member 50 described in the second embodiment.

Similar to the third embodiment, the fourth embodiment also has the covering member 40 extending rearward of the vehicle beyond the opening 18 in the housing 10. Specifically, an upper covering part 44, a right covering part 42, and a left covering part 43 of the covering member 40 respectively extend rearward of the vehicle beyond the opening 18 of the housing 10. As shown in FIG. 8, in an initial state, a distance D3 in the vehicle vertical direction between a vehicle rearward portion 441 of the covering member 40 and an inner edge 181 of the opening 18 of the housing 10 on a rear side of the vehicle is greater than 0. Therefore, in the initial state, the vehicle rearward portion 441 of the covering member 40 is positioned below the opening 18 in the vehicle.

Although not shown in the drawing, in a full stroke state, a distance in the vehicle vertical direction between the vehicle rearward portion 441 of the covering member 40 and the inner edge 181 of the opening 18 of the housing 10 on a rear side of the vehicle is also greater than 0. Therefore, in the full stroke state, the vehicle rearward portion 441 of the covering member 40 is positioned below the opening 18 in the vehicle. In such manner, it is possible for the covering member 40 to prevent foreign matter from entering the interior space 11 of the housing 10 through the opening 18, even when, for example, the foreign matter falls off from a sole of the driver's shoes. Further, the covering member 40 can also prevent foreign matter from entering the pedal operating area 23 and the opening 18 when the foreign matter approaches the pedal device from the rear side of the vehicle.

The pedal device of the fourth embodiment described above can also achieve the same effects as those of the first embodiment and the like.

### Fifth Embodiment

The following describes the fifth embodiment of the present disclosure. The fifth embodiment is similar to the third embodiment except for a part of the configuration of a covering member 40 modified from the corresponding configuration of the third embodiment. Accordingly, only parts different from the corresponding parts of the third embodiment are herein described. In the specification, a gap may mean a “width of a gap.”

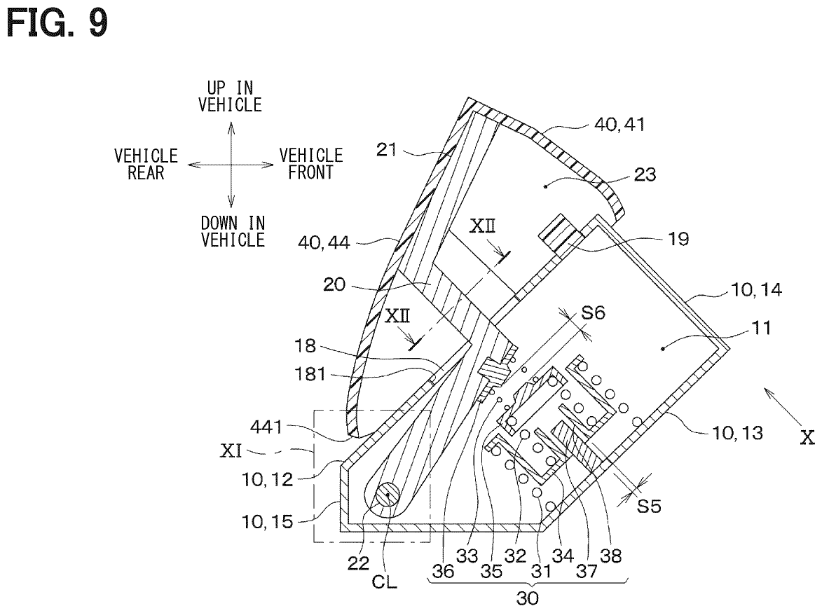

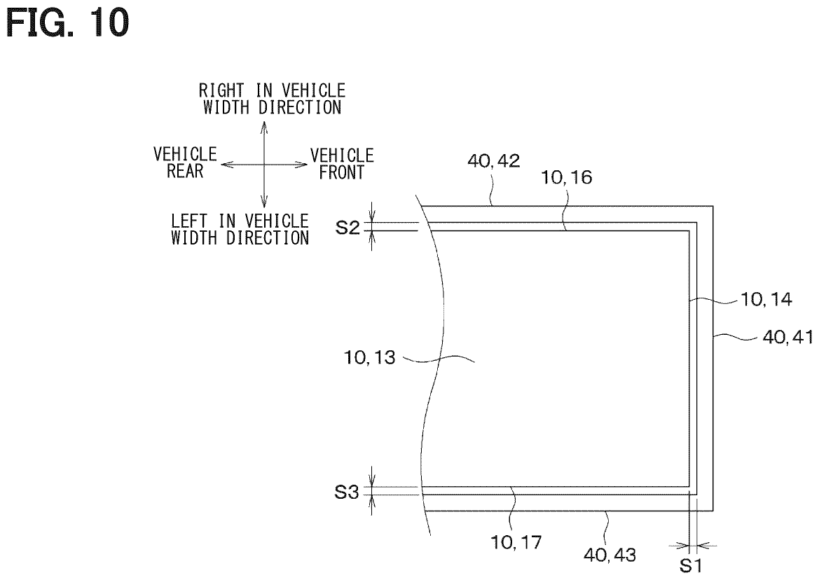

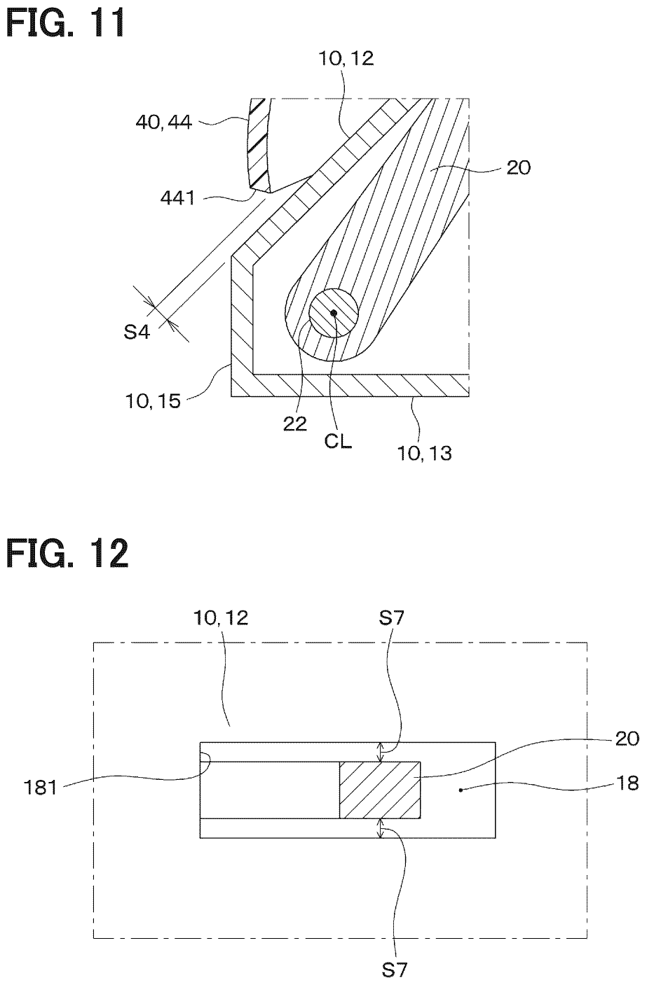

As shown in FIGS. 9 and 10, in the fifth embodiment, a gap between a housing 10 side portion of a front covering part 41 and a front wall 14 of the housing 10 in an initial state is referred to as a “gap S1 between the front covering part 41 and the housing 10.” In the initial state, a gap between the housing 10 side portion of a right covering part 42 and a right side wall 16 of the housing 10 is referred to as a “gap S2 between the right covering part 42 and the housing 10.” In the initial state, a gap between the housing 10 side portion of a left covering part 43 and a left side wall 17 of the housing 10 is referred to as a “gap S3 between the left covering part 43 and the housing 10. As shown in FIGS. 9 and 11, in the initial state, a gap between a vehicle rearward portion 441 of an upper covering part 44 and a top wall 12 of the housing 10 is referred to as a “gap S4 between the upper covering part 44 and the housing 10.”

In the following explanation, the “gap S1 between the front covering part 41 and the housing 10,” the “gap S2 between the right covering part 42 and the housing 10,” the “gap S3 between the left covering part 43 and the housing 10,” and the “gap S4 between the top covering part 44 and the housing 10” may be collectively called as “gap S1-S4 between a housing 10 side portion of the covering member 40 and the housing 10.”

As shown in FIG. 9, a gap at a sliding portion of the configuration in the housing 10 where the gap remains constant and unchanged according to a rotational movement of a pedal arm 20 is referred to as a “constant gap S5 in the housing 10.” In FIG. 9, as an example, a constant gap S5 between an inner wall of an insertion hole 38 of a first holder 34 and a central rod 37 is illustrated as the “constant gap S5 in the housing 10.”

In the fifth embodiment, “the gap S1-S4 between the housing 10 side portion of the covering member 40 and the housing 10” is smaller than “the constant gap S5 in the housing 10.” In such manner, a size of foreign matter that can enter the inner space 11 of the housing 10 from “the gap S1-S4 between the housing 10 side portion of the covering member 40 and the housing 10” is limited to be smaller than the “constant gap S5 in the housing 10.” Therefore, a component that makes up the “constant gap S5 in the housing 10” is prevented from locking due to biting of foreign matter.

Further, as shown in FIG. 9, a gap of a portion of the configuration in the housing 10 in the initial state where the gap changes in response to the rotational movement of the pedal arm 20 is referred to as a “variable gap S6 in the housing 10.” In FIG. 9, the gap S6 between a second holder 35 and a third holder 36 is illustrated as an example of the “variable gap S6 in the housing 10.” In the fifth embodiment, “the gap S1-S4 between the housing 10 side portion of the covering member 40 and the housing 10” is smaller than “the variable gap S6 in the housing 10.” In such manner, a size of foreign matter that can enter the inner space 11 of the housing 10 from “the gap S1-S4 between the housing 10 side portion of the covering member 40 and the housing 10” is limited to be smaller than the “variable gap S6 in the housing 10.” Therefore, a component that makes up the “variable gap S6 in the housing 10” from locking due to biting of foreign matter.

As shown in FIGS. 9 and 12, a gap between the inner wall of the opening 18 of the housing 10 and the pedal arm 20 is referred to as a “gap S7 between the inner wall of the opening and the pedal arm 20.” In the fifth embodiment, “the gap S1-S4 between the housing 10 side portion of the covering member 40 and the housing 10” is smaller than “the gap S7 between the inner wall of the opening and the pedal arm 20. In such manner, a size of foreign matter that can enter the pedal operating area 23 from “the gap S1-S4 between the housing 10 side portion of the covering member 40 and the housing 10” is limited to be smaller than “the gap S7 between the inner wall of the opening and the pedal arm 20.” In such manner, the pedal arm 20 is prevented from locking due to biting of foreign matter into the “gap S7 between the inner wall of the opening and the pedal arm 20.”

Further, as shown in FIGS. 10 and 11, in the fifth embodiment, “gap S4 between the upper covering part 44 and the housing 10” is greater than the “gap S1 between the front covering part 41 and the housing 10”, the “gap S2 between the right covering part 42 and the housing 10” and the “gap S3 between the left covering part 43 and the housing 10.” In such manner, foreign matter that has entered the pedal operating area 23 through the “gap S1 between the front covering part 41 and the housing 10,” the “gap S2 between the right covering part 42 and the housing 10,” or the “gap S3 between the left covering part 43 and the housing 10” can be discharged through the “gap S4 between the top covering part 44 and the housing 10”.

As mentioned above, the “gap S4 between the upper covering part 44 and the housing 10” is smaller than the “constant gap S5 in the housing 10” or the “variable gap S6 in the housing 10.” Therefore, a component that makes up the “constant gap S5 in the housing 10” or the “variable gap S6 in the housing 10” is prevented from locking due to biting of foreign matter.

Note that the “gap S1-S4 between the housing 10 side portion of the covering member 40 and the housing 10” may be zero. In other words, the pedal device may have a configuration in which the housing 10 side portion of the covering member 40 and the housing 10 slide with each other.

### Sixth Embodiment

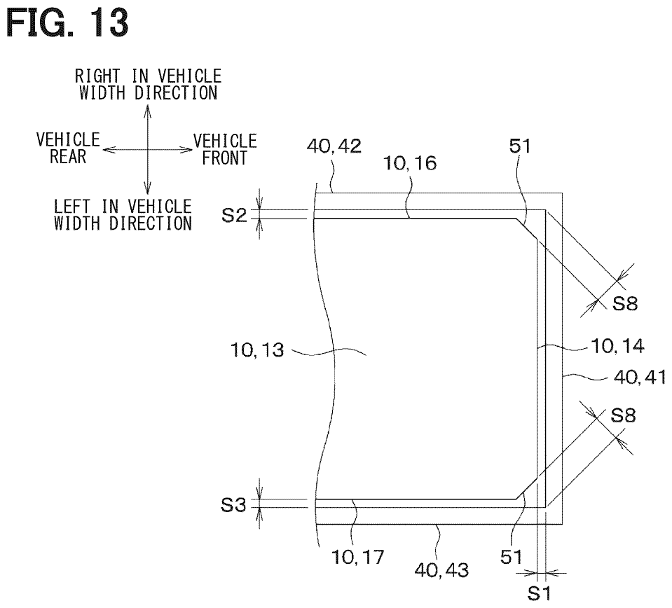

The sixth embodiment is a modification example of the fifth embodiment. FIG. 13, which is referred to in the explanation of the sixth embodiment, is a diagram of a section corresponding to FIG. 10, which is referred to in the explanation of the fifth embodiment. As shown in FIG. 13, in the sixth embodiment, a front wall 14 and a right side wall 16 of a housing 10 are connected by a sloping surface 51. Further, the front wall 14 and a left side wall 17 of housing 10 are also connected by the sloping surface 51. In such case, “the gap S1-S4 between the housing 10 side portion of a covering member 40 and the housing 10” described above includes “a gap S8 between the housing 10 side portion of the covering member 40 and the inclined surface 51.” In the following description, “the gap S8 between the housing 10 side of the covering member 40 and the sloping surface 51” is referred to as “a gap S8 between the covering member 40 and the sloping surface 51.

“The gap S8 between the covering member 40 and the sloping surface 51” is smaller than “the constant gap S5 in the housing 10.” Further, “the gap S8 between the covering member 40 and the sloping surface 51” is smaller than “the variable gap S6 in the housing 10.” “The gap S8 between the covering member 40 and the sloping surface 51” is smaller than “the gap S7 between the inner wall of the opening and the pedal arm 20.” “The gap S8 between the covering member 40 and the sloping surface 51” is smaller than “the gap S4 between the upper covering part 44 and the housing 10.” In such manner, the sixth embodiment can also achieve the same effects as those of the fifth embodiment.

### Seventh Embodiment

The following describes the seventh embodiment of the present disclosure. The fourth embodiment is similar to the first to sixth embodiment except for a part of the configuration of the housing 10 modified therefrom. Accordingly, only parts different from the corresponding parts of the first to sixth embodiment are herein described.

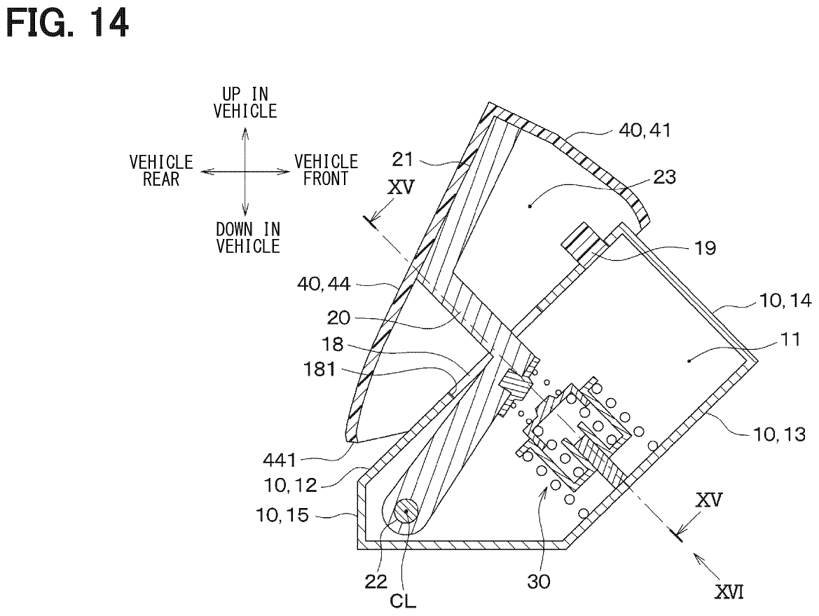

As shown in FIGS. 14 through 16, in the seventh embodiment, a housing 10 includes a housing body 52 and rib-shaped portions 53 protruding from an outer wall of the housing body 52 to the right and left in the vehicle width direction. Note that the housing body 52 includes a bottom wall 13, a front wall 14, a rear wall 15, a right side wall 16, and a left side wall 17. The rib-shaped portion 53 includes a top wall 12.

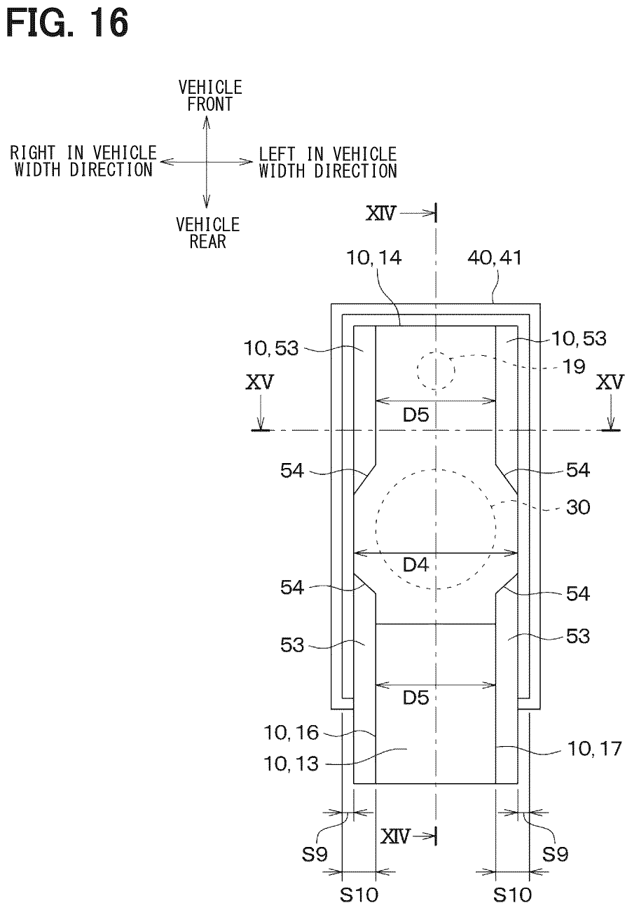

As shown in FIG. 16, in the housing body 52, a distance D4 between the left side wall 17 and the right side wall 16 at a position where a reaction force generating mechanism 30 is arranged in an interior space 11 is greater than a distance D5 between the left side wall 17 and the right side wall 16 at a position where the reaction force generating mechanism 30 is not arranged in the interior space 11. Therefore, the left side wall 17 and the right side wall 16 of the housing 10 are provided with steps 54 at positions connecting (i) a position where the reaction force generating mechanism 30 is arranged in the interior space 11 and (ii) a position where the reaction force generating mechanism 30 is not arranged in the interior space 11.

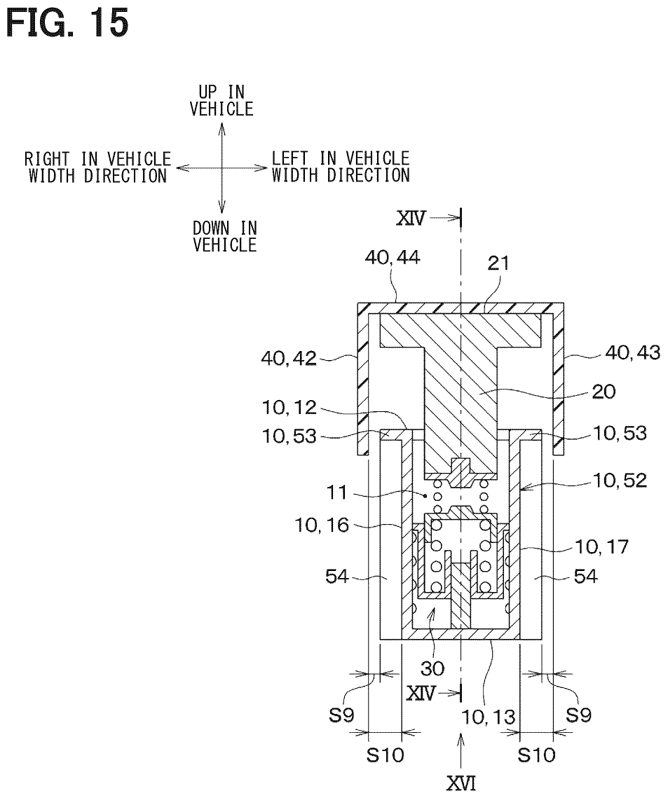

As shown in FIGS. 15 and 16, the rib-shaped portions 53 are (i) the right side wall 16 of the housing 10 that protrudes from a portion on an upper wall 12 side to the right in the vehicle width direction and (ii) the left side wall 17 of the housing 10 that protrude from a portion on the upper wall 12 side to the left in the vehicle width direction. Note that the rib-shaped portion 53 can also be designated as a portion of the upper wall 12 that protrudes to the right and left of the housing body 52 in the vehicle width direction. The rib-shaped portion 53 has an external shape that extends along a straight line in a front-rear direction of the vehicle. Thus, the rib-shaped portion 53 absorbs the steps 54 on the left side wall 17 and right side wall 16 of the housing 10, making an outer shape of the housing 10 on an upper wall 12 side simplified. The front covering part 41, the right covering part 42, and the left covering part 43, which are provided in the covering member 40, cover an outside of such simply-shaped ribbed portion 53.

In the seventh embodiment described above, the housing 10 has the rib-shaped portions 53 protruding from the outer wall of the housing body 52 to the right and left in the vehicle width direction. “The gap S1-S4 between the housing 10 side of the covering member 40 and the housing 10” includes “a gap S9 between a housing 10 side portion of the covering member 40 and the rib-shaped portion 53.” According to the above, even when the housing body 52 has a complex shape, by providing the rib-shaped portion 53, the “gap S9 between the housing 10 side portion of the covering member 40 and the rib-shaped portion 53” while the covering member 40 is formed to have a simple shape.

A gap S10 between a housing 10 side portion of the covering member 40 and the housing body 52” is greater than “the gap S9 between the housing 10 side of the covering member 40 and the rib-shaped portion 53.” Therefore, it is possible to prevent foreign matter from being caught in “the gap S9 between the housing 10 side portion of the covering member 40 and the rib-shaped portion 53.”

### Eighth Embodiment

The eighth embodiment will be described in the following. The eighth embodiment is similar to the seventh embodiment except for a part of the configuration of the covering member 40 modified from the corresponding configuration thereof. Accordingly, only parts different from the corresponding parts of the seventh embodiment are herein described.

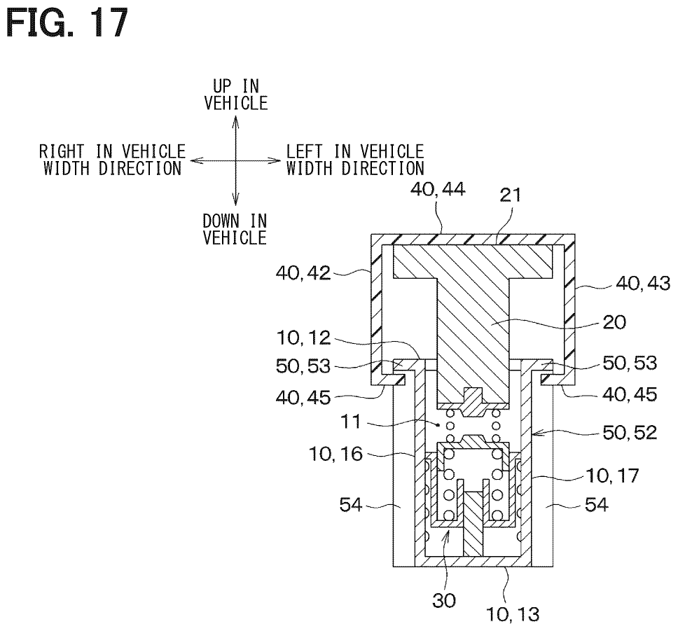

As shown in FIG. 17, in the eighth embodiment, a housing 10 also has rib-shaped portions 53. On the other hand, the covering member 40 has a covering-side rib-shaped portion 45 that protrudes toward a housing body 52 at a point extending toward a lower side of the vehicle from the rib-shaped portion 53. Further, the rib-shaped portion 53 of the housing 10 and the covering-side rib-shaped portion 45 overlap in the vertical direction of the vehicle, forming a labyrinth structure. In such manner, the eighth embodiment is configured to reliably prevent foreign matter from entering a pedal operating area 23.

### Ninth Embodiment

The ninth embodiment will be described in the following. The ninth embodiment is similar to the first to eighth embodiment except for a part of the configuration of the housing 10 modified from the corresponding configuration thereof. Accordingly, only parts different from the corresponding parts of the first to eighth embodiment are herein described.

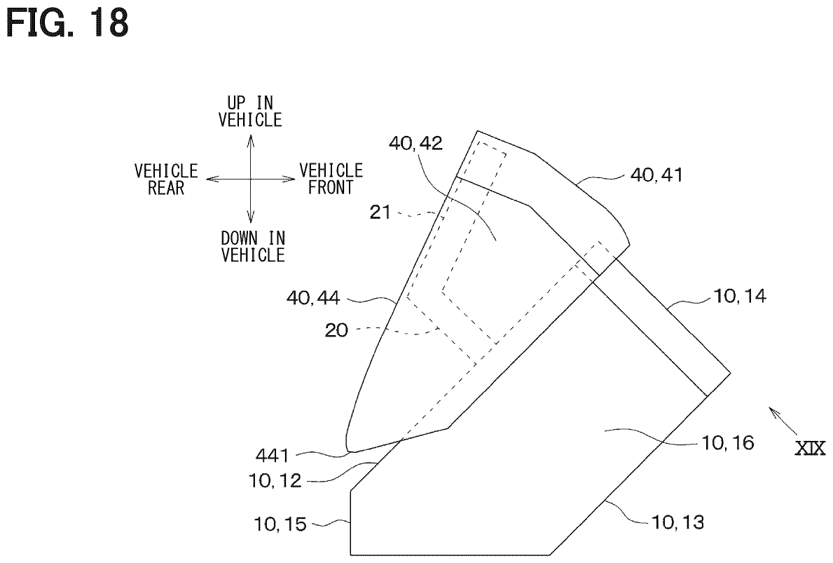

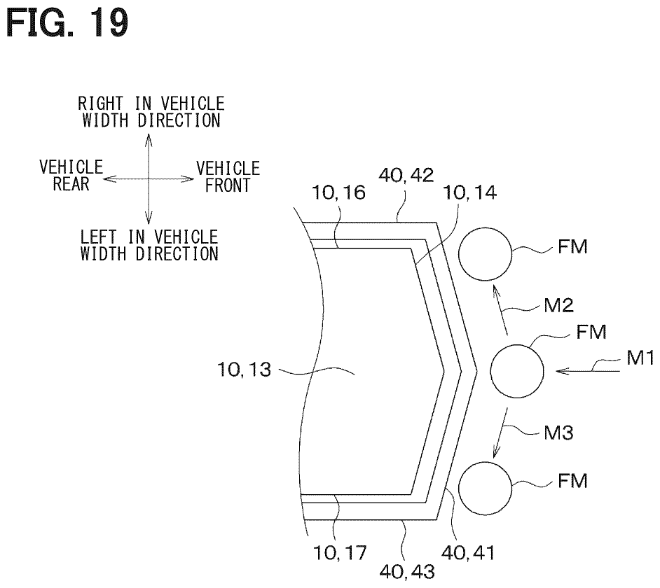

As shown in FIGS. 18 and 19, in the ninth embodiment, a front wall 14 of a housing 10 has a slope shape with a left and right portions in the vehicle width direction positioned rearward of the vehicle than a center portion thereof. The front covering part 41 also has a slope shape with the left and right portions in the vehicle width direction positioned rearward of the vehicle than the center portion thereof.

In such manner, as shown by arrows M1, M2, and M3 in FIG. 19, when foreign matter FM approaches the pedal device from the front side of the vehicle, it will not stop at the front wall 14 or at the front covering part 41 of the housing 10, but will change its rolling direction to the left or right in the vehicle width direction. Therefore, the pedal device is capable of preventing intrusion of foreign matter into the pedal operating area 23.

### Tenth Embodiment

The tenth embodiment will be described in the following. The tenth embodiment is a modification of the ninth embodiment.

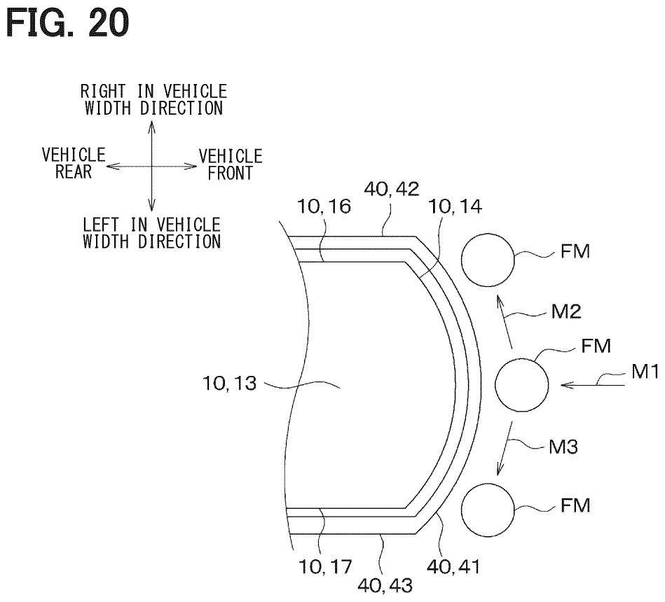

As shown in FIG. 20, in the ninth embodiment, the front wall 14 of the housing 10 has a curved-convex shape toward the front of the vehicle. The front covering part 41 also has a curved-convex shape toward the front of the vehicle.

In such manner, as shown by arrows M1, M2, and M3 in FIG. 20, when foreign matter FM approaches the pedal device from the front side of the vehicle, it will not stop at the front wall 14 or at the front covering part 41 of the housing 10, but will change its rolling direction to the left or right in the vehicle width direction. Therefore, the pedal device of the tenth embodiment achieves the same effects as the ninth embodiment.

### Eleventh Embodiment

The eleventh embodiment will be described in the following. Since the eleventh embodiment is the same as the first to tenth embodiment except that a configuration to which a sensor 55 and a sensor cover 56 are added as a change from the configuration of the first to tenth embodiment, only parts different from the first to tenth embodiment will be described.

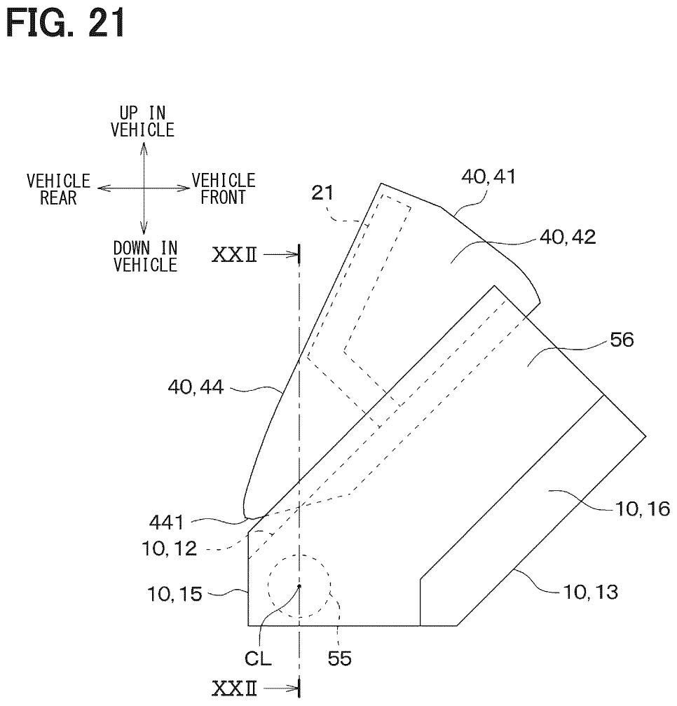

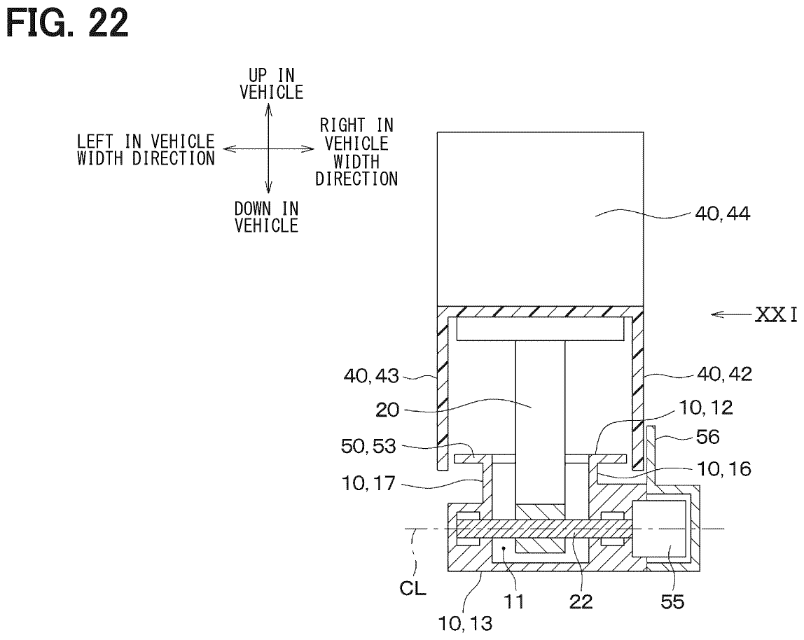

As shown in FIGS. 21 and 22, the eleventh embodiment of the pedal device includes a sensor 55 and a sensor cover 56. The sensor 55 is an angle sensor or a stroke sensor that detects an angle of rotation of a pedal arm 20. As described in the first embodiment, the electrical signals output from the sensor 55 are transmitted to an electronic control device installed in the vehicle.

The sensor cover 56 is provided on an outside of a housing 10, and protects the sensor 55. The sensor cover 56 extends toward the top of the vehicle from a position where the sensor 55 is provided, and covers an outside of a housing 10 side of the covering member 40. Note that the sensor cover 56 covered on an outside of a housing 10 side portion of the covering member 40 in the state all through the initial state to the full stroke state. Specifically, the sensor cover 56 covers the outside of the housing 10 side portion of the right covering part 42. In such manner, foreign matter is prevented from getting caught between a vehicle floor and the covering member 40 (specifically, the right covering part 42). Thus, locking of the pedal arm 20 due to intrusion of foreign matter is preventable. Note that the sensor cover 56 may be installed on a left side of the vehicle in the vehicle width direction relative to the pedal device.

### Twelfth Embodiment

The twelfth embodiment will be described in the following. Since the twelfth embodiment is the same as the first to eleventh embodiment except that a shape of the floor is changed from the configuration of the first to eleventh embodiment, only parts different from the first to eleventh embodiment will be described.

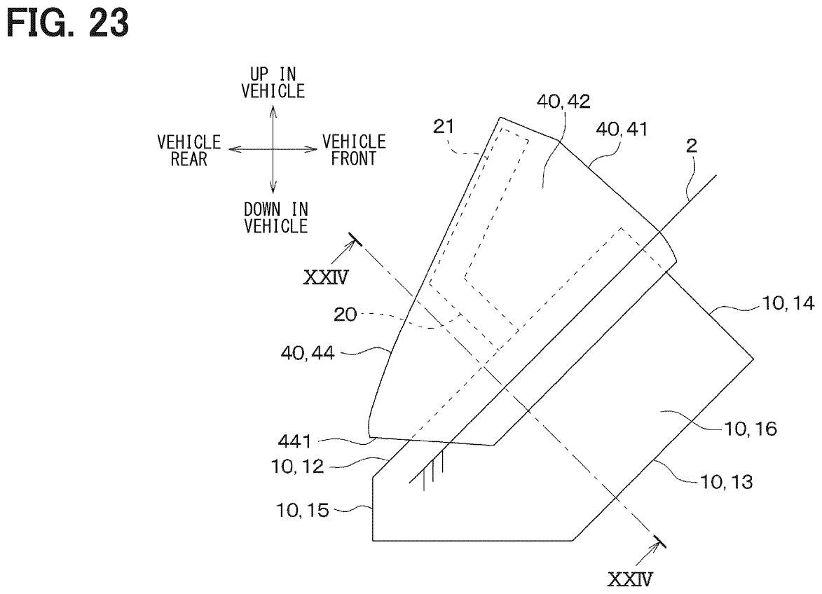

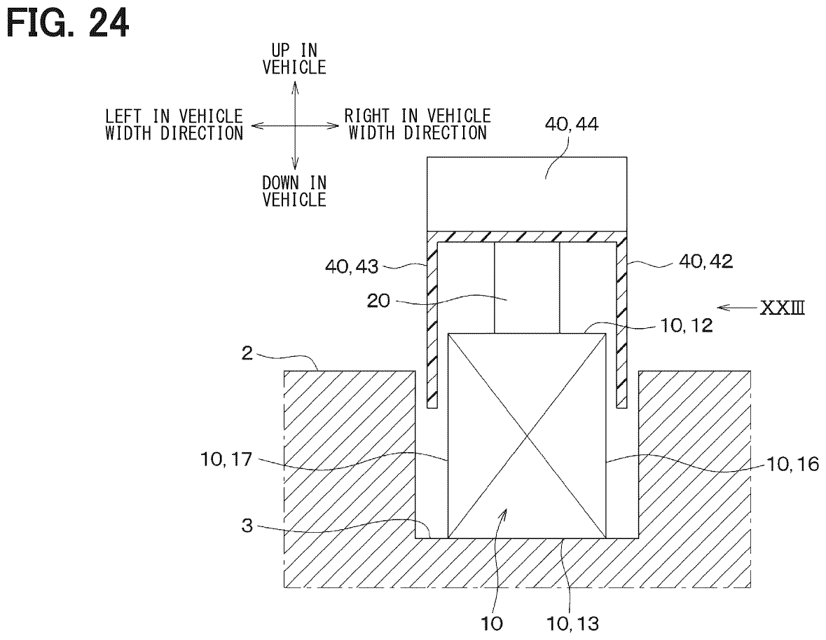

As shown in FIGS. 23 and 24, a housing 10 of the pedal device in the twelfth embodiment is fixed inside a groove 3 provided on a floor 2 of the vehicle. A housing 10 side portion of the covering member 40 is in an inside of the groove 3 provided on the floor 2 of the vehicle in the state all through the initial state to the full stroke state. In such manner, foreign matter is prevented from being caught between the floor 2 of the vehicle and the covering member 40. Thus, locking of a pedal arm 20 due to intrusion of foreign matter is preventable.

### Thirteenth Embodiment

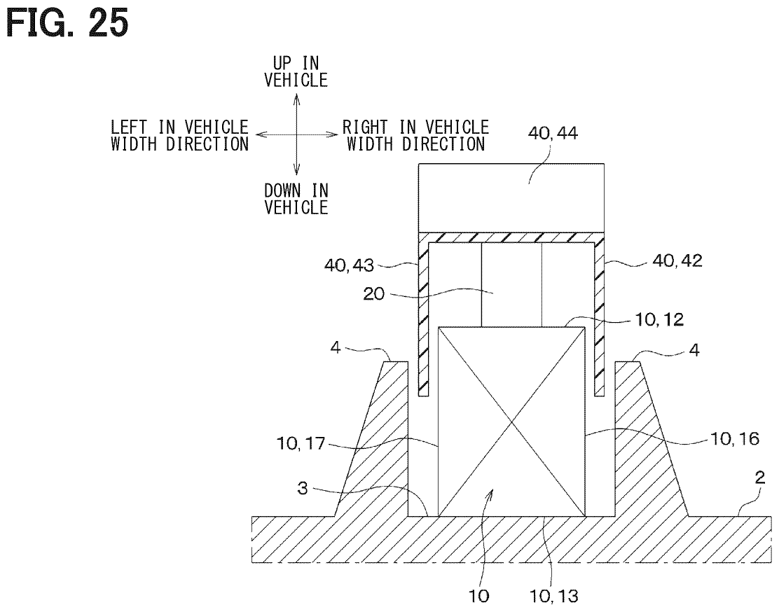

The thirteenth embodiment will be described in the following. The thirteenth embodiment is a modification of the twelfth embodiment. As shown in FIG. 25, in the thirteenth embodiment, a housing 10 of the pedal device is also fixed to an inside of a groove 3 that is provided on the floor 2 of the vehicle. A housing 10 side portion of the covering member 40 is in an inside of the groove 3 on the floor 2 of the vehicle in the state all through the initial state to the full stroke state. In the thirteenth embodiment, the groove 3 provided on the floor 2 of the vehicle is formed at a position between two protrusions 4 on the floor 2. The pedal device of the thirteenth embodiment described above can also achieve the same effects as those of the twelfth embodiment.

### Other Embodiments

(1) In each of the above-described embodiments, a brake pedal device is described as an example of a pedal device, but the pedal device may be an accelerator pedal device.

(2) In each of the above-described embodiments, a brake pedal device as an example of a pedal device is described as being used in a brake-by-wire system. However, the configuration is not limited thereto. A brake pedal device as an example of a pedal device may be used, for example, in a brake system in which a master cylinder and a brake pedal device are mechanically connected. In such case, the pedal device can be configured without the reaction force generating mechanism 30.

The present disclosure is not limited to the above-described embodiments, and can be appropriately modified. The above-described embodiments and a part thereof are not irrelevant to each other, and can be appropriately combined with each other unless the combination is obviously impossible. The configuration element(s) of each of the above embodiments is/are not necessarily essential unless it is specifically stated that the constituent element(s) is/are essential in the above embodiment, or unless the constituent element(s) is/are obviously essential in principle. Further, in each of the embodiments described above, when numeric such as the number, numerical value, quantity, range, and the like of the constituent elements of the embodiment are referred to, except in case where the numerical values are expressly indispensable in particular, the case where the numerical values are obviously limited to a specific number in principle, and the like, the present disclosure is not limited to the specific number. Further, in each of the embodiments described above, when referring to the shape, positional relationship, and the like of the constituent elements and the like, it is not limited to such shape, positional relationship, and the like, except for the case where the constituent elements are specifically specified, the case where the constituent elements are fundamentally limited to a specific shape, positional relationship, and the like.

### Aspects of Present Disclosure

The present disclosure described above can be understood as having the following aspects, for example.

### Aspect 1

An organ-type pedal device to be mounted on a vehicle, the pedal device includes: a housing (10) fixed to the vehicle; a pedal arm (20) provided to be rotatable within a predetermined angular range about a predetermined axis (CL) with respect to the housing, and having a pedal operation part (21) as a part to be stepped on by a driver on an upper side of the vehicle above the axis; and a covering member (40) provided at the pedal arm and covering all or a part of an area outside of the housing, where the pedal arm rotates and operates, which is a vehicle front side, a right side in a vehicle width direction, and a left side in the vehicle width direction with respect to a pedal operating area (23).

### Aspect 2

In the pedal device of aspect 1, the covering member includes an upper covering part (44) that faces toward a rear and upper side of the vehicle.

### Aspect 3

In the pedal device of aspect 1 or 2, the covering member extends from the pedal arm toward the housing, and at least a part of a housing side portion of the covering member covers an outside of the housing.

### Aspect 4

In the pedal device of any one of aspects 1 to 3,
the covering member covers all of the vehicle front side, the right side in the vehicle width direction and the left side in the vehicle width direction with respect to the pedal operating area.

### Aspect 5

In the pedal device of any one of aspects 1 to 4,
the housing includes an opening (18) provided in an upper wall (12) to open toward an upper side of the vehicle, and in an initial state in which no pedal force is applied to the pedal operation part by the driver, a vehicle rearward portion (441) of the covering member is positioned below the opening in the vehicle.

### Aspect 6

In the pedal device of any one of aspects 1 to 5,
the housing includes an opening (18) provided in an upper wall (12) to open toward an upper side of the vehicle, and in a full stroke state in which the pedal operation part is closest to the housing by a driver's pedal force applied to the pedal operation part, a vehicle rearward portion (441) of the covering member is positioned below the opening in the vehicle.

### Aspect 7

In the pedal device of any one of aspects 1 to 6,
in an initial state in which no pedal force is applied to the pedal operation part by the driver, a gap (S1-S4, S8) between a housing side portion of the covering member and the housing is smaller than a constant gap (S5) of a sliding portion of a configuration provided in the housing, wherein the constant gap does not change due to a rotational movement of the pedal arm and remains constant.

### Aspect 8

In the pedal device of any one of aspects 1 to 7,
in an initial state in which no pedal force is applied to the pedal operation part by the driver, a gap (S1-S4, S8) between a housing side portion of the covering member and the housing is smaller than a changeable gap (S6) of a portion of a configuration in the housing in the initial state, wherein the changeable gap changes in response to a rotational movement of the pedal arm.

### Aspect 9

In the pedal device of any one of aspects 1 to 8,
the housing includes an opening (18) provided in an upper wall (12) to open to an upper side of the vehicle, and in an initial state in which no pedal force is applied to the pedal operation part by the driver, a gap (S1-S4, S8) between a housing side portion of the covering member and the housing is smaller than a gap (S7) between an inner wall of the opening and the pedal arm.

### Aspect 10

In the pedal device of any one of aspects 1 to 9,
the covering member includes a front covering part (41) facing a front and upper side in the vehicle, a right covering part (42) facing a right side in the vehicle width direction, a left covering part (43) facing a left side in the vehicle width direction, and an upper covering part (44) facing a rear and upper side in the vehicle, and
in an initial state in which no pedal force is applied to the pedal operation part by the driver, a gap (S4) between a vehicle rearward portion (441) of the upper covering part and the housing is greater than a gap (S1, S2, S3) between (i) a housing side portion of the front covering part, the right covering part and the left covering part and (ii) the housing, and is smaller than (a) a changeable gap (S6) of a portion of a configuration in the housing in the initial state where the changeable gap changes in response to a rotational movement of the pedal arm or (b) a constant gap (S5) of a sliding portion of a configuration provided in the housing, where the constant gap does not change due to a rotational movement of the pedal arm and remains constant.

### Aspect 11

In the pedal device of any one of aspects 1 to 10,
the housing includes a housing body (52) and a rib-shaped portion (53) protruding from an outer wall of the housing body to right or left in a vehicle width direction, and a gap (S1-S4, S8) between a housing side portion of the covering member and the housing includes a gap (S9) between the housing side portion of the covering member and the rib-shaped portion of the housing.

### Aspect 12

In the pedal device of aspect 11,
the covering member includes a rib-shaped portion (45) that protrudes toward the housing body at a position extending toward a lower side of the vehicle from the rib-shaped portion of the housing, and
the rib-shaped portion of the housing and the rib-shaped portion of the covering member overlap in a vertical direction of the vehicle, to configure a labyrinth structure.

### Aspect 13

In the pedal device of any one of aspects 1 to 12,
a front wall (14) of the housing facing a front of the vehicle has a curved-convex shape toward the front of the vehicle, and
a front covering part (41) of the covering member facing the front of the vehicle has a curved-convex shape toward the front of the vehicle.

### Aspect 14

In the pedal device of any one of aspects 1 to 12,
a front wall (14) of the housing facing a front of the vehicle has a slope shape in which left and right portions of the front wall in the vehicle width direction are positioned rearward of the vehicle than a center portion thereof, and
a front covering part (41) of the covering member facing the front of the vehicle has a slope shape in which left and right portions of the front covering part in the vehicle width direction are positioned rearward of the vehicle than the center portion thereof.

### Aspect 15

The pedal device of any one of aspects 1 to 14 further includes: a sensor (55) configured to detect an angle of rotation of the pedal arm; and a sensor cover (56) provided at an outside of the housing and protecting the sensor. In addition, the sensor cover covers an outside of a housing side portion of the covering member in any state from (i) an initial state in which no pedal force is applied to the pedal operation part by the driver to (ii) a full stroke state in which the pedal operation part is closest to the housing by a driver's pedal force applied to the pedal operation part.

### Aspect 16

In the pedal device of any one of aspects 1 to 15, a housing side portion of the covering member is positioned in an inside of a groove (3) provided on a floor (3) of the vehicle, in any state from (i) an initial state in which no pedal force is applied to the pedal operation part by the driver to (ii) a full stroke state in which the pedal operation part is closest to the housing by a driver's pedal force applied to the pedal operation part.

### Aspect 17

In the pedal device of any one of aspects 1 to 16, a part or all of the covering member is made of a material, which is resin, rubber or elastomer, to be elastically deformed by a driver's pedal force.

1. An organ-type pedal device to be mounted on a vehicle, the pedal device comprising:
a housing fixed to the vehicle;
a pedal arm provided to be rotatable within a predetermined angular range about a predetermined axis with respect to the housing, and having a pedal operation part as a part to be stepped on by a driver on an upper side of the vehicle above the axis; and
a covering member provided at the pedal arm and covering all or a part of an area outside of the housing, where the pedal arm rotates and operates, which is a vehicle front side, a right side in a vehicle width direction, and a left side in the vehicle width direction with respect to a pedal operating area.

2. The pedal device of claim 1, wherein
the covering member includes an upper covering part that faces toward a rear and upper side of the vehicle.

3. The pedal device of claim 1, wherein
the covering member extends from the pedal arm toward the housing, and at least a part of a housing side portion of the covering member covers an outside of the housing.

4. The pedal device of claim 1, wherein
the covering member covers all of the vehicle front side, the right side in the vehicle width direction and the left side in the vehicle width direction with respect to the pedal operating area.

5. The pedal device of claim 1, wherein
the housing includes an opening provided in an upper wall to open toward an upper side of the vehicle, and
in an initial state in which no pedal force is applied to the pedal operation part by the driver, a vehicle rearward portion of the covering member is positioned below the opening in the vehicle.

6. The pedal device of claim 1, wherein
the housing includes an opening provided in an upper wall to open toward an upper side of the vehicle, and
in a full stroke state in which the pedal operation part is closest to the housing by a driver's pedal force applied to the pedal operation part, a vehicle rearward portion of the covering member is positioned below the opening in the vehicle.

7. The pedal device of claim 1, wherein
in an initial state in which no pedal force is applied to the pedal operation part by the driver, a gap between a housing side portion of the covering member and the housing is smaller than a constant gap of a sliding portion of a configuration provided in the housing, wherein the constant gap does not change due to a rotational movement of the pedal arm and remains constant.

8. The pedal device of claim 1, wherein
in an initial state in which no pedal force is applied to the pedal operation part by the driver, a gap between a housing side portion of the covering member and the housing is smaller than a changeable gap of a portion of a configuration in the housing in the initial state, wherein the changeable gap changes in response to a rotational movement of the pedal arm.

9. The pedal device of claim 1, wherein
the housing includes an opening provided in an upper wall to open to an upper side of the vehicle, and
in an initial state in which no pedal force is applied to the pedal operation part by the driver, a gap between a housing side portion of the covering member and the housing is smaller than a gap between an inner wall of the opening and the pedal arm.

10. The pedal device of claim 1, wherein
the covering member includes a front covering part facing a front and upper side in the vehicle, a right covering part facing a right side in the vehicle width direction, a left covering part facing a left side in the vehicle width direction, and an upper covering part facing a rear and upper side in the vehicle, and
in an initial state in which no pedal force is applied to the pedal operation part by the driver, a gap between a vehicle rearward portion of the upper covering part and the housing is greater than a gap between (i) a housing side portion of the front covering part, the right covering part and the left covering part and (ii) the housing, and is smaller than (a) a changeable gap of a portion of a configuration in the housing in the initial state where the changeable gap changes in response to a rotational movement of the pedal arm or (b) a constant gap of a sliding portion of a configuration provided in the housing, where the constant gap does not change due to a rotational movement of the pedal arm and remains constant.

11. The pedal device of claim 1, wherein
the housing includes a housing body and a rib-shaped portion protruding from an outer wall of the housing body to right or left in a vehicle width direction, and
a gap between a housing side portion of the covering member and the housing includes a gap between the housing side portion of the covering member and the rib-shaped portion of the housing.

12. The pedal device of claim 11, wherein
the covering member includes a rib-shaped portion that protrudes toward the housing body at a position extending toward a lower side of the vehicle from the rib-shaped portion of the housing, and
the rib-shaped portion of the housing and the rib-shaped portion of the covering member overlap in a vertical direction of the vehicle, to configure a labyrinth structure.

13. The pedal device of claim 1, wherein
a front wall of the housing facing a front of the vehicle has a curved-convex shape toward the front of the vehicle, and
a front covering part of the covering member facing the front of the vehicle has a curved-convex shape toward the front of the vehicle.

14. The pedal device of claim 1, wherein
a front wall of the housing facing a front of the vehicle has a slope shape in which left and right portions of the front wall in the vehicle width direction are positioned rearward of the vehicle than a center portion thereof, and
a front covering part of the covering member facing the front of the vehicle has a slope shape in which left and right portions of the front covering part in the vehicle width direction are positioned rearward of the vehicle than the center portion thereof.

15. The pedal device of claim 1, further comprising:
a sensor configured to detect an angle of rotation of the pedal arm; and
a sensor cover provided at an outside of the housing and protecting the sensor, wherein
the sensor cover covers an outside of a housing side portion of the covering member in any state from (i) an initial state in which no pedal force is applied to the pedal operation part by the driver to (ii) a full stroke state in which the pedal operation part is closest to the housing by a driver's pedal force applied to the pedal operation part.

16. The pedal device of claim 1, wherein
a housing side portion of the covering member is positioned in an inside of a groove provided on a floor of the vehicle, in any state from (i) an initial state in which no pedal force is applied to the pedal operation part by the driver to (ii) a full stroke state in which the pedal operation part is closest to the housing by a driver's pedal force applied to the pedal operation part.

17. The pedal device of claim 1, wherein
a part or all of the covering member is made of a material, which is resin, rubber or elastomer, to be elastically deformed by a driver's pedal force.
